(19) United States
(12) Patent Application Publication
(10) Pub. No.: US 2020/0318396 A1
(43) Pub. Date: Oct. 8, 2020

(54) Device for Handcuffs

(71) Applicant: Yaniv Herman, Lod (IL)

(72) Inventor: Yaniv Herman, Lod (IL)

(21) Appl. No.: 16/720,034

(22) Filed: Dec. 19, 2019

Related U.S. Application Data
(63) Continuation-in-part of application No. 14/818,363, filed on Aug. 5, 2015, now abandoned.

(51) Int. Cl. E05B 75/00

(52) U.S. Cl. CPC E05B 75/00

(57) ABSTRACT

This present Invention provides novelty in device for handcuffs which is purpose-built for constraining the hands of the handcuffed person. Wherein, the device designated to enables handcuffs which can constrain both hands of the handcuffed person, and where an extension to the handcuffs provides, additionally, a means to allow the constraining of finger movements of the handcuffed person, such that both wrists of the handcuffed person are one against the other and the fingers of his one hand are against the fingers of his other hand, thus limiting to some degree their natural freedom of movement by the device of the handcuffs which constitute this present Invention.

### BACKGROUND OF THE INVENTION

This present invention is in the field of handcuffs, and more specifically, this present Invention combines a handcuff and instrument which enables the user to handcuff the hands of the person to be handcuffed, and, at least to a certain extent, also to immobilise the fingers of his hands one against another.

It is known to a person skilled in the art that handcuffs, which are used to limit the movement of the hands of the person on whom the handcuffs are put, is a device already in existence for hundreds of years, in various configurations which enable the securing of one hand of the handcuffed person to his other hand, such as to prevent the handcuffed person from moving both hands freely, as he could before the use of the handcuffs.

Handcuffs are characteristically used on people who have been arrested or are imprisoned by law-enforcement agencies, for example prisoners imprisoned in a prison or arrestees detained by the police.

Such arrestees or prisoners, whose freedom of movement is limited by law, or by a court order, or by the authority of a person in authority, in general, when they are transferred from secure premises, for example from a prison cell or from a police cell, the person in authority has the desire to prevent the escape of these arrestees or prisoners or any aggressive act on their part, and thus constrains their full bodily freedom of movement, for example of their arms and sometimes also of their legs; this is a common and necessary situation.

There are additional methods for constraining the movement of the body members of a person, for example a person in lawful custody, for example a straightjacket, used principally in institutions dealing with mental health problems. Such a straightjacket includes sleeves for the arms and hands which imprison the arms of the person wearing the straightjacket inside the straightjacket, with no possibility of movement.

This present Invention provides novelty in situations where there is a need for handcuffs which also limits some movement of the fingers of the handcuffed person, in such a manner that the fingers of each hand do not have their normal freedom of movement.

The need for solutions that enables the limitation of fingers movement of some handcuffed persons is indicated by the fact that in handcuffs presently-available to the police, for example, one wrist is secured against the other wrist by two handcuff clamps, secured to each other with by a connector; in this situation the fingers of the hand of the handcuffed person are free. these facts may lead to dangers situation where person under arrest, for example, act a some forbidden action using the fingers of his hands, for example, taking control of a policeman's gun.

The device of this present invention enables handcuffs which enable the securing of the wrists of the handcuffed person one to the other, as in the Prior-Art ordinary handcuffs, wherein, additionally, some additional sections of the device of this present Invention added and integrated with such standard handcuff, designated to fits and cover over at least some sections of the fingers of some handcuffed persons. Wherein, such structure of such device enables to restrain the fingers of some handcuffed person's to the “glove shaped section” of the present device to limits movement abilities of some of such fingers, and furthermore, to restrain the fingers of one of the handcuffed person's hand to the fingers of his other hand.

Wherein, this is made possible by the device sections that enable a glove shape sections that fitted to accommodates at list part of such handcuffed person's fingers, wherein, such device providing a separation between the handcuffed person's fingers, and limiting the movement of such handcuffed fingers.

### SUMMARY OF THE INVENTION

This present Invention provides novelty in handcuffing device, wherein, such device enables to secure to handcuffed person's wrists one to the other, such as to limit their freedom of movement, wherein additionally, such device enables some additional sections of such device of this present Invention that designated to cover over at least part of the fingers of the handcuffed person, or immobilises a some sections of his fingers in such a way that secure at least part of the fingers of the handcuffed person's one hand to the fingers of his other hand.

Wherein, such structure of such device enables to restrain the fingers of some handcuffed person's to the “glove shaped section”, wherein, such “glove shaped section” structured out of at list some compartments, wherein, each compartment fitted to accommodates one finger of the person, enabling separation between such fingers, wherein, such structure designated to accommodates some fingers of the present device to limits some movement abilities of some of such fingers, and furthermore, restrain the fingers one from the other fingers, and restrain the fingers of one of the handcuffed person's hand to the fingers of his other hand.

Wherein, this is made possible by the device sections that enable a glove shape sections that fitted to accommodates at list part of such handcuffed person's fingers separately one from the other fingers, wherein, such device providing a separation between the handcuffed person's fingers, and limiting the movement of such handcuffed fingers.

Wherein, such “glove shape sections” that fitted to accommodates at list part of such handcuffed person's fingers, are enabled in one implementation of the present invention by stiff materials that are not flexible, such as hard plastic and metals materials.

Furthermore, in another implementation of the present invention, such sections that are designated to accommodates some fingers in separate compartment designated to each finger, enabled by combining some stiff non-flexible materials with some flexible materials to preformed such sections, for example, allowing some stiff non-flexible materials to enables some compartment to each separate finger, however, allowing some flexible materials that designed to connect some section of such stiff non-flexible materials to enable some limited stretching of such finger compartment section to be fitted to different persons fingers sizes.

Opening and closing of at least one or more specific parts of the device, according to need, is provided, in a manner that enables widening of part of the section of the handcuffs which is made for the insertion of the wrists of the person to be handcuffed, one against the other wherein, such section can be narrowed again, for example, after the insertion of the hands of the person to be handcuffed, and where it is also possible to lock at least one part of the handcuff device by narrowing and then widening again, to suit different hand size and to enabling the insertion and the pulling out some persons hands from such handcuffs.

Additionally, a particular sections of the device enables the putting-on glove-like bags, wherein each “bag shape” compartment fitted to one finger accommodation, covering over the fingers or part of the fingers of the handcuffed person, wherein, the glove-like bags effectively deny the handcuffed person the possibility to move his fingers freely

Wherein, such “glove shape sections” that fitted to accommodates at list part of such handcuffed person's fingers, wherein, at list some of such fingers has a specific one chamber that accommodates such finger, and of each one of such fingers, are enabled in one implementation of the present invention by stiff materials that are not flexible, such as hard plastic, or some metals materials. Furthermore, in another implementation of the present invention, such sections enabled by combining some stiff non-flexible materials with some flexible materials such as rubber bands that enables to starch some metal net section for example to enables the present invention goals.

### BRIEF DESCRIPTION OF THE DRAWINGS

The accompanying drawings are included in this present Patent Application with the objective of providing a greater understanding of the Invention, and are included and form an integral part of this present specification. The drawings illustrate various embodiments of the Invention, and together with the description, serve the purpose of clarifying the principles of operation of the Invention, all exclusively as examples, and not with the objective of limiting the Invention to these and only these descriptions.

FIG. 1 is a schematic description which illustrates an example, which is included in the scope of this present Invention, and which illustrates a handcuffing device which includes parts of the device which enable the restriction of the freedom of movement of the fingers of the person upon whom the handcuffs are put, according to the method and the device of this present Invention.

FIG. 2 is a schematic description of handcuffs in existence in the prior art, in US Patent Application 2005/0262895 A1 before the invention of the method and device of this present Invention.

FIG. 3 is a schematic description which illustrates a further example included within the scope of this present Invention, which illustrates a handcuffing device which includes some sections of such device which enables to restricts of the freedom of movement of the fingers and yet enables different size of fingers to be accommodates in such device of the present Invention.

### DESCRIPTION OF THE PREFERRED EMBODIMENTS

The description of the drawings of this annex and the drawings to which reference is made are included within this Patent Application with the objective of providing greater understanding of the Invention, and are included and form an integral part of this specification. The description of the drawings provides a more detailed explanation of the different embodiments of the invention, and, together with the drawings themselves, and the other components of the Patent Application document, serve the purpose of explaining the principles of operation of the Invention, all exclusively as examples, and not with the objective of limiting the Invention to these and only these descriptions.

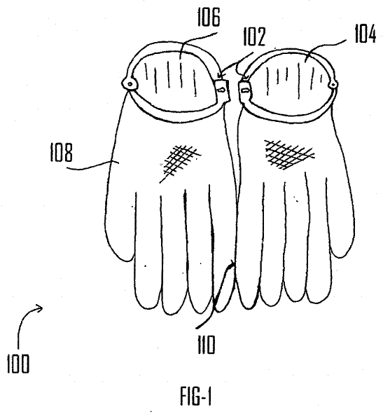

FIG. 1 is a schematic description which illustrates an example, which illustrates handcuffing device 100, which includes opening device section 102, and enables through them to increase the diameter of the entry opening and the insertion through this opening of the hands of the person being handcuffed, where the hands of the person being handcuffed are inserted into openings 104 and 106, and his fingers are inserted according to the intended position of each finger in the glove-shaped part 108 of the device, where there is separator 110 inside glove 108, which prevents contact of the fingers of one hand of the handcuffed person with the fingers of his second hand, this in a manner which enables the restriction of movement of the fingers of the handcuffed person, according to the method and the device of this present Invention.

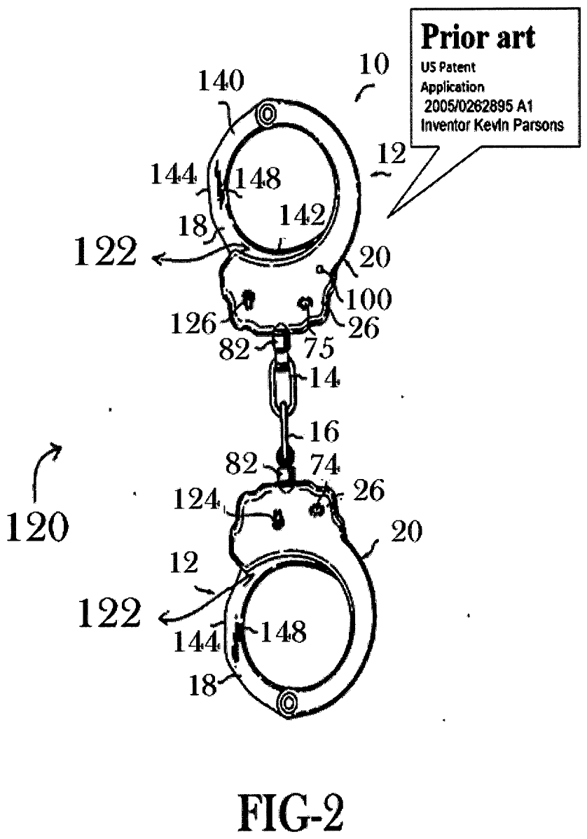

FIG. 2 is a schematic description which illustrates handcuffs 120, which exist in the prior art before the invention of the method and device of this present Invention, where clamp 122 enables opening, closing and locking, according to need, in order to enable the insertion and the locking of the wrists of the person being handcuffed. Wherein, the present invention uses such prior art handcuffs in the upper section of the device of the present invention.

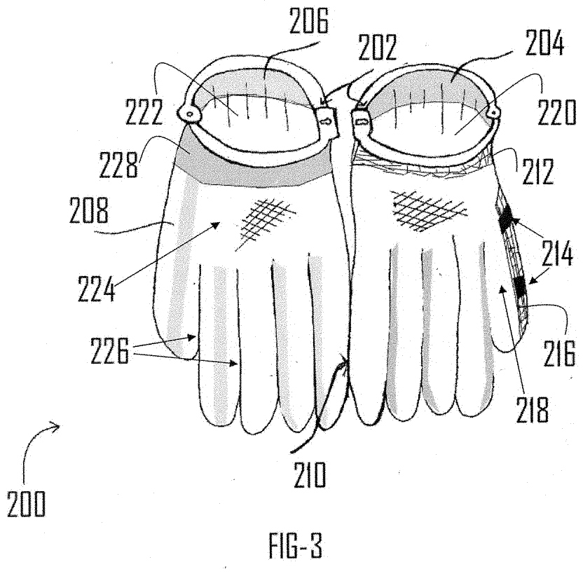

FIG. 3 is a schematic description which illustrates an example of one implement of the present invention, which illustrates handcuffed glove device 200,

Wherein, such device 200 of the present invention is “glove fitted in shape to accommodate each finger of some handcuffed person's in some separate glove section”, and the two sections of the device designed for accommodating each one of the handcuffs are connected to each other, for example in section 210.

Wherein, at list some of such fingers having specific one glove chamber that accommodates each one of such fingers.

Wherein, such handcuffed glove device of the present invention applied and preformed in some of the device sections surface 218, 224, 208 for example by stiff materials that are not flexible, such as hard plastic, or some metals materials.

Wherein, furthermore, some of the handcuffed glove device sections applied and preformed by combining some stiff non-flexible materials with some flexible materials such as rubber bands 214 for example, that enables to starch some metal net sections 212, 216 for example that are between the finger glove sections to allows entrance of the fingers and different size of fingers, also illustrate in the present drawing by “colour filing sections” such as in sections 228, 204, 206 for example to enables the present invention goals.

Wherein, such combination of different materials in the present invention, designated to enables some adjustable stretch or shrink option for different hand sizes and different fingers sizes in a limited way that does not allow free movement of hands and fingers.

Wherein, the present invention uses some Prior Art Handcuffs 202 in the upper section of the device 200, and to such section 202 fastened the glove shape sections 204, 212 and 206, 228 of the present invention.

Wherein, the hands of the person being handcuffed are inserted through openings 220 and 222, and his fingers are inserted according to the intended position of each finger in the glove-shaped sections fitted to each finger. Wherein, each of the finger chambers section of the present glove device is fastened permanently to the nearest section designated for another finger accommodation, for example connecting section 226.

Wherein, such operation apply in a manner which enables the restriction of movement of the fingers of the handcuffed person, where at this stage, openings 220 and 222 are closed and tightened by sections 202 and fitted to the wrists of the person being handcuffed with the device 200, until the person being handcuffed can no longer remove the device from his hands; thus the locking the diameter of the opening as decided by the person in authority, is enabled via lock 202 and the device of the present Invention.

1. handcuffed glove device wherein, such device designated to secure and restrain handcuffed person's wrists and fingers and limit some of its movement abilities, wherein such device structure comprising:
A. The glove device in shape that fitted to accommodate each finger of the two palms of some handcuffed person's, wherein, such accommodation enabled in some separate glove compartments, wherein;
B. The glove device comprising from two sections, each section designated to accommodate the fingers of one palm of the handcuffed person's, wherein;
C. The glove device two sections are secured to each other, wherein;
D. Accommodating each one of the glove sections device, designated to accommodates handcuffed person's palms in a manner that permanently fixed handcuffed person's palms to each other, wherein;
E. Such “glove shaped section” structured out of at list some compartments, wherein, each compartment fitted to accommodates specific one finger of the handcuffed person's in some separate chamber, wherein;
F. Each compartment that accommodates each finger is separate from some other compartments that accommodate other fingers of the handcuffed person's fingers, wherein;
G. Such glove device designated for handcuffed persons as in the present invention, applied and preformed in some of the device sections and compartments by stiff materials that are not flexible, such as hard plastic, or some metals materials, wherein;
H. Furthermore, some of the handcuffed glove device sections and compartments applied and preformed by combining some stiff non-flexible materials with some flexible materials such as rubber bands for example, that enables to starch some metal net sections, for example sections that are between, or connecting some the finger glove compartments. Furthermore, such combining some stiff non-flexible materials with some flexible materials, can be applied at some section of the present device that requires some limited stretching abilities, to allows entrance of the hands and fingers and to enables the device to fit different size of fingers, wherein;
I. such combination of different materials in the present invention, designated to enables some adjustable stretch or shrink option for different hand sizes and different fingers sizes in a limited way that does not allows free movement of hands and fingers, wherein;
J. Wherein, the present invention uses some “Prior Art” Handcuffs in the upper section of the device, to enables fastening and locking such sections to the glove shape sections and to the handcuffed person's wrists, wherein;
K. The hands of the person being handcuffed are to be inserted through the device upper opening sections, and his fingers are to be inserted according to the intended position of each finger in the glove-shaped compartments fitted to accommodates each finger separately, wherein;
L. Each of each finger compartments and chambers section of the glove device is fastened permanently to at list one of the nearest other compartments designated for another finger accommodation.
